(19) United States
(12) Patent Application Publication
(10) Pub. No.: US 2007/0233597 A1
(43) Pub. Date: Oct. 4, 2007

(54) LEAST COST NETWORK ROUTING FOR ELECTRONIC TRANSACTIONS

(75) Inventors: William S. Petersen, Englewood, CO (US); Ian Drysdale, Parkland, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/682,856

(22) Filed: Mar. 6, 2007

Related U.S. Application Data
(60) Provisional application No. 60/779,910, filed on Mar. 6, 2006.

(51) Int. Cl. G06Q 40/00

(52) U.S. Cl. 705/39

(57) ABSTRACT

The present invention generally relates to systems and methods for determining a lowest cost debit/credit network for an electronic transaction and methods for routing an electronic transaction through a lowest cost network for the transaction. The invention generally involves providing a transaction table array and determining a lowest cost debit/credit network from the transaction table array for the electronic transaction.

### CROSS REFERENCES TO RELATED APPLICATIONS

This application is a continuation in part application and claims the benefit of U.S. Provisional Patent Application No. 60/779,910, filed Mar. 6, 2006, the complete disclosure of which is herein incorporated by reference.

### BACKGROUND OF THE INVENTION

The present invention relates to systems and methods for routing electronic transactions through debit/credit networks, and more particularly to least cost network routing of electronic transactions. In one aspect, the invention is particularly useful in cases where no rules prohibit least cost network routing of such transactions, where no rule proscribes how such transaction should be routed or in cases where conflicts exist between or among rules as to the routing of such transactions.

Due to increased share of electronic transactions in the marketplace, the cost and volume of such transactions have become a concern for merchants, ATM owner/operators and debit/credit processors. In performing commercial electronic transactions, merchants, ATM owner/operators and debit/credit processors have many debit/credit networks from which to choose, each associated with various transactional costs and fees. The most prevalent method for minimizing debit/credit processing costs generally involves a static ranking of estimated network costs, usually based on a merchant's average ticket amounts and available networks. However, the merchant and ATM owner/operators stand to lose a great amount of time and money due to the inefficiencies of such methods.

Consequently, there is a need for improved systems and methods for routing electronic transactions which routes transactions based on lowest cost.

### BRIEF SUMMARY OF THE INVENTION

To address these and other needs, the present invention relates to systems and methods for determining lowest cost debit/credit network for an electronic transaction and routing thereof. In some cases, the techniques of the invention may be employed in cases where no rules prohibit the least cost routing of such transactions, in cases where no rule proscribes how such transaction should be routed or in cases where conflicts exist between or among rules as to the network to which the transactions should be routed. More specifically, those skilled in the art will appreciate that certain debit/credit network rules exist which dictate that transactions should be routed in a certain way. In the absence of such rules prohibiting routing of transactions in a particular was, or proscribing how such transactions are to be routed or where a conflict exists between or among rules as to which network transactions are to be routed any of the techniques described herein may be used.

In a first aspect, a method for determining a lowest cost debit/credit network for an electronic transaction is provided. The method generally comprises: providing a transaction table array comprising a series of tables; selecting an appropriate transaction table from the transaction table array based at least on the amount of the transaction; and determining the lowest cost debit/credit network from the selected transaction table to thereby determine the lowest cost debit/credit network for the transaction.

In another aspect, a method of routing an electronic transaction involving a merchant or ATM owner/operator and a financial institution which issues a debit/credit account through a lowest cost debit/credit network for the transaction is provided. The method generally comprises: providing a merchant or ATM owner/operator network list which corresponds to the merchant or ATM owner/operator identification number, the merchant or ATM owner/operator network list comprising debit/credit networks available for access by the merchant or ATM owner/operator; providing a financial institution network list which corresponds to the issuing financial institution of a cardholder account, the financial institution network list comprising debit/credit networks available for access by the issuing financial institution; providing a transaction table array comprising a series of tables; matching the debit/credit networks of the merchant or ATM owner/operator network list and the financial institution network list and generating a merchant or ATM owner/operator-financial institution network list with the matched debit/credit networks of the merchant or ATM owner/operator network list and the financial institution network list; selecting an appropriate transaction table from the transaction table array based at least on a transaction amount; cross-referencing the debit/credit networks sorted in the selected transaction table with the debit/credit networks of the merchant or ATM owner/operator-financial institution network list; determining the lowest cost debit/credit network in common between the selected transaction table and the merchant or ATM owner/operator-financial institution network list; and routing the transaction through the determined lowest cost network.

In certain embodiments, each table includes a list of debit/credit network sorted based on network fee amounts, each table is generated based on at least a discrete predetermined transaction amount, and the series of tables is based on a predetermined transaction table amount interval up to a cap amount.

In other embodiments, each table is further generated based on merchant type and/or transaction type. In such embodiments, the appropriate table may be further selected based on at least transaction amount, as well as merchant type and/or transaction type.

In other embodiments, the methods may further comprise determining the availability of the first selected lowest cost debit/credit network for the transaction, and selecting the next lowest cost debit/credit network that is available if the first selected lowest cost debit/credit network is not available.

### BRIEF DESCRIPTION OF THE DRAWINGS

FIG. 1 illustrates an exemplary system of the invention.

FIG. 2 illustrates an exemplary method of the invention, with optional steps indicated in dashed lines.

FIG. 3 illustrates another exemplary method of the invention, with optional steps indicated in dashed lines.

### DETAILED DESCRIPTION OF THE INVENTION

In accordance with the present invention, systems and methods for providing dynamic, least cost routing of electronic debit and/or credit transactions is provided using a transaction table array. The systems and methods of the invention generally comprise selecting a least cost debit/credit network for an electronic transaction based on a transaction table from the transaction table array. The systems and methods of the invention are useful for least cost routing of PIN-secured transactions, signature debit transactions, online transactions, offline transactions, and other payment types supported by electronic debit and/or credit networks known in the art.

I. Least Cost Routing Transaction Table Array

In a first aspect, the invention generally provides an array of transaction tables. The transaction table array includes a series of transaction tables, wherein each transaction table in the array includes a list of debit/credit networks sorted by transaction fee amount. As may be recognized by those skilled in the art, transaction fee amount may be based on a percentage of the transaction amount, may be based on a percentage of the transaction amount plus a flat fee, etc. However, the invention is not so limited, and any network fee arrangement known in the art may be used to generate the transaction table arrays of the invention.

By way of background, some transactions have previously been routed based on tables that were generated based on an average ticket amount, and used as an estimate, often resulting in the selection of an inefficient network. However, in accordance with the present invention, the transaction table arrays are generated based on individual transaction amounts over select transaction amount intervals. Specific transaction tables within a transaction table array are then used on a transaction by transaction basis to select a lowest cost network without relying on general estimates, thereby eliminating the inefficiencies of the prior art.

A separate transaction table may be generated based on, at least in part, a discrete predetermined transaction amount. For instance, a separate transaction table may be generated for a 1 penny transaction amount up to, e.g., $500 transaction, etc., depending on the merchant type The series of transaction tables may based on a predetermined transaction table amount interval up to a cap amount. For instance, 1 cent, 5 cent, 10 cent, 25 cent, 50 cent, 1 dollar, 2 dollar, 5 dollar, 7 dollar, 10 dollar, etc. intervals, and may range from a, e.g., $0.01, $0.25, $1 transaction amounts up to a cap amount, e.g., $500, as set by the debit/credit network.

The transaction tables may also be generated based in part on merchant type. Typical merchant types include grocery merchants, retail merchants, quick service restaurant merchants, supermarket, petroleum, etc, as known in the industry. For instance, a separate transaction table may be generated for a grocery merchant for 1 penny up to a cap amount, e.g., $500. Various transaction amount intervals may be used, e.g., including 1 cent, 5 cent, 10 cent, 25 cent, 50 cent, 1 dollar, 2 dollar, 5 dollar, etc., intervals. As recognized by those skilled in the art, certain larger merchants may have individual or negotiated transaction table amounts which differ from the merchant type standard.

The transaction tables may alternatively, or may additionally, be generated based in part on transaction type. Typical electronic transactions include credit card transactions, debit card transactions, automated teller machine transactions, electronic funds transfer transactions, electronic check acceptance transactions, traditional check acceptance transactions, etc. The transaction may be run over merchant networks, third party processor networks, ATM networks and the like. However, any transaction that may be processed through debit/credit networks may be used in the context of the invention. For instance, a separate transaction table may be generated for a debit card transaction at 1 penny up to a cap amount, e.g., $500; for a credit card transaction at 1 penny up to a cap amount, e.g., $500; for a electronic check acceptance transaction at a grocery merchant at 1 penny up to a cap amount, e.g., $500; a traditional check acceptance transaction at a clothing merchant at 1 penny up to a cap amount, e.g., $500; an automated teller machine transaction at a specialty merchant at 1 penny up to a cap amount, e.g., $500. Again, various transaction amount intervals may be used, e.g., including 1 cent, 5 cent, 10 cent, 25 cent, 50 cent, 1 dollar, 2 dollar, 5 dollar, etc., intervals.

The transaction tables may also take various network rules, regulations and contractual agreements into account in the ranking and prioritizing of networks. For instance, in certain embodiments, the transaction tables may be generated such that various network rules, as generally known in the art, are implemented during generation of the tables.

In some cases, routing may be based on whether certain rules dictate the routing practices of certain types of transactions. Merely by way of example, and not by way of limitation, certain network rules state that all BINS for a given network are to be routed to that particular network. In such cases, the transaction may be routed based on BINS included in network BIN file, rather than on least cost routing. For dual priority conflicts, a network routing rule may permit the transaction to be routed to the least cost network (of the networks in conflict). In such cases, the routing techniques of the invention may be used. As another example, if there is an issuer priority routing rule, the transaction may be routed to the network prioritized by the issuer with the given network routing rule, thereby overriding least cost routing. More specifically, with issuer priority routing, issuers may choose a certain network as priority route network. A flag is included in the network's BIN file, indicating the priority status of the BIN. In such cases, the transactions may be routed based on issuer priority flags provided in network BIN file. As a farther example, the routing rule may be a state routing rule dictating that the transaction should be routed to the network indicated by the state routing rule. For instance, the state/network may dictate that all BINS for this network that occur within the state are to be routed to that network. Finally, certain operating rules may also state that if a card base is not flagged as priority in its regional network BIN file, the transaction must route to the regional network over a national network (such as with Maestro & Interlink).

In cases where there are no routing rules or prohibiting regulations, the invention may be used to route the network according to the least cost routing as described herein.

The transaction tables may be generated on a periodic basis, or on a notice basis, when debit/credit network fees are revised. In this manner, dynamic transaction table arrays may be generated for use in the systems and methods of the inventions for least cost routing of electronic transaction, in a time efficient manner.

In other embodiments, the transaction tables may be generated on a real-time basis as the transaction information is processed. In such embodiments, the transaction table information may be generated based only on the specific transaction amount, and the networks may be ranked based on that specific amount. Generally, to facilitate real-time calculates, the transaction table array may be prepared with the desired formulas for calculating the network fees, and the fees may then be calculated in real-time as the transaction amount is processed for least cost routing.

II. Least Cost Routing Systems

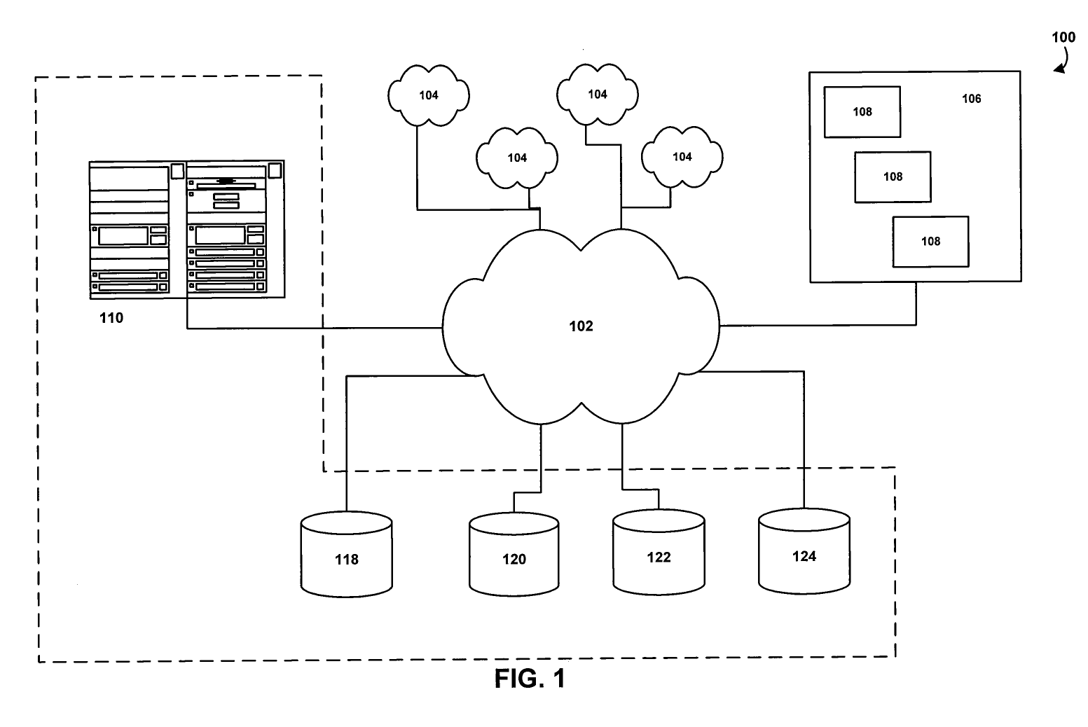

Turning now to FIG. 1, a system 100 is illustrated for dynamic least cost routing of electronic debit and/or credit transactions in accordance with embodiments of the invention. System 100 can be implemented in communications network environment (generally indicated by reference number 102). Communications network 102 can be any network capable of supporting electronic debit and/or credit transactions including ATM transactions. Exemplary system 100 comprises electronic transaction terminals 108 located at a merchant location 106 in communication with computer/server 110. Computer/server 110 is in turn in communication with one or more databases 118, 120, 122, 124 and one or more debit/credit networks 104. Merely by way of example, electronic transaction terminal 108, server 110, databases 118, 120, 122, 124 and debit/credit network 104 may be in communication via any suitable communications network 102, such as a local area network, wide area network, the internet and/or any other telecommunications network, a wireless network and the like. Computer/server 110 may be located at the merchant location, or alternatively may be located at a service provider location. Likewise, as discussed in more detail herein, databases 118, 120, 122, 124 may be located at the merchant location, or may alternatively be located at a service provider location.

Electronic transaction terminal 108 may be a point-of-sale terminal, an automated teller machine terminal, a cash register terminal, an electronic check verification terminal, etc. However, the invention is not so limited, and any suitable electronic transaction terminal known in the art may be used in connection with the present invention.

Debit/Credit Network 104 may be any known debit or credit network, including STAR, PULSE, INTERLINK, MAESTRO, CU24, AFFN, ACCEL, EXCHANGE, NETS, SHAZAM, ATH, ALASKA OPTION, JEANIE, TEMPO PAYMENTS, CIRRUS, FASTBANK, INSTANT CASH, MINIBANK, MONEY NETWORK, PEAK, PLUS, NYCE, ALERT, VISA, MasterCard, DISCOVER, American Express, etc. However, the invention is not so limited, and any debit and/or credit network available in the geographic location of interest may be used in the context of the present invention.

In particular embodiments, system 100, server 110, and/or electronic transaction terminal 108 can, in some embodiments, comprise a plurality of processors. Each of the plurality of processors can perform one or more of the processing tasks discussed herein. Further, each of the plurality of processors can be in communication with one or more computer readable media, including, for instance disk drives, memory devices and the like which can include instructions executable by the processors to perform the functions discussed herein.

In accordance with various embodiments of the invention, system 100 can include one or more databases 118, 120, 122, 124, etc. which can be used to store a variety of information related to the inventive methods discussed herein such as the transaction table array described above. Those skilled in the art will appreciate that although, for purposes of clarity, databases 118, 120, 122, 124 are illustrated separately on FIG. 1, other embodiments of the invention might incorporate all of the stored data within a single database and/or organize data structures differently than as illustrated herein. Further, although illustrated as separate physical elements in FIG. 1, databases 118, 120, 122, 124 may alternatively be housed within server computer 110 (as indicated by the dashed line in FIG. 1). As discussed herein, when reference is made to server computer 110 including or comprising a database, it is understood that the database may be within the computer housing itself, or may be a separate structure in communication with server computer 110.

In embodiments utilizing the information bus model discussed herein, the information discussed with respect to databases 118, 120, 122, 124 may be pushed and/or pulled from the bus, allowing for data acquisition from a wide variety of sources. The term “database,” therefore, should be interpreted to mean a collection of information rather than read as a limitation to a particular physical or logical structure or organization. Databases 118, 120, 122, 124 can be in communication with server computer 108 either through network 104 (as illustrated on FIG. 1), through direct communication (e.g., SCSI connection, etc.) and/or through any other method known in the art, so long as server computer 108 can access the information stored within databases 118, 120, 122, 124.

As will be discussed in more detail below, databases 118, 120, 122, 124 may comprise various combinations of transaction tables for use during least cost routing of electronic transaction in accordance with the methods of the invention. By way of non-limiting example, databases 118, 120, 122, 124 may comprise transaction tables listing debit/credit networks sorted by transaction fee charged by the debit/credit network for the particular transaction for which the table has been generated.

Those skilled in the art will recognize that there are a variety of ways of storing composite information in a database, any of which can be implemented in accordance with various embodiments of the invention. Further, those skilled in the art will recognize that there are a variety of ways in which server computer 110 might interface with database 118, 120, 122, 124. In a particular aspect server 110 can access information in database 118, 120, 122, 124 on a periodic basis or on demand. Various standardized (e.g., OOBC, SQL, XML, etc.) and/or proprietary data access methodologies known in the art may be used to access databases 118, 120, 122, 124. Further, data may either be pushed from a database or “pulled” by server 110.

Alternatively, databases 118, 120,122, 124 and/or server 110 can engage in a practice known in the art as “push-pull” data warehousing, whereby information can be shared with and/or pulled from another source. Such data warehousing can be done within an enterprise or between multiple enterprises and can be performed using any of a variety of methods known to those skilled in the art including, merely by way of example, XML data transfers. In these and other ways, embodiments of the present invention, as discussed above, can interface with an information bus operation on an intra-company or inter-company basis, and can both pull information from that bus and push information to the information bus. Thus, systems in accordance with embodiments of the invention can easily integrate with other data management systems in the provider's network, for example by utilizing the information bus methodology described briefly herein and known to those skilled in the art.

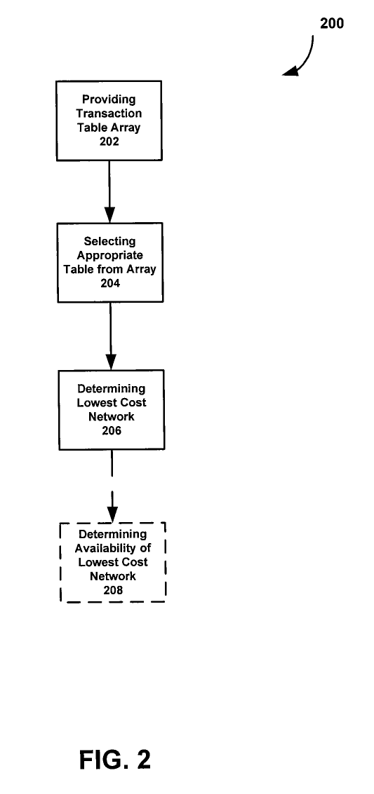

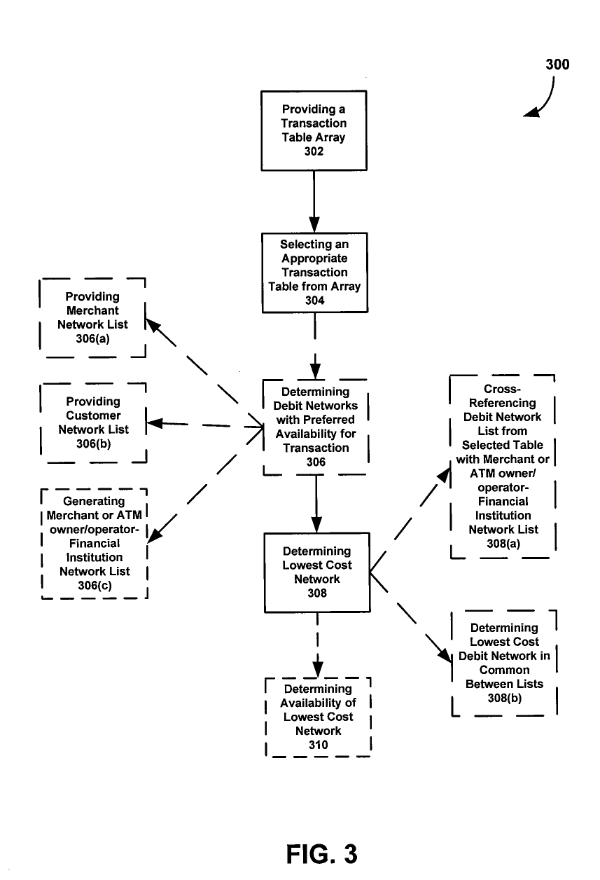

In another aspect of the invention, methods for determining a lowest cost debit/credit network for an electronic transaction and methods for routing an electronic transaction through a lowest cost network for the transaction are provided. As mentioned above, the methods generally involve providing a transaction table array and determining a lowest cost debit/credit network from the transaction table array for the electronic transaction. Certain embodiments will be discussed in more detail below with reference to FIGS. 2 and 3.

III. Least Cost Routing Methods

Turning now to FIG. 2, a method 200 is illustrated is for determining a lowest cost debit/credit network for an electronic transaction. Although for ease of description, method 200 will be described by reference to system 100, those skilled in the art will understand that methods in accordance with various embodiments of the invention are not limited to any particular hardware or physical structure(s). In accordance with exemplary method 200, a method for determining a lowest cost debit/credit network for an electronic transaction is provided. Generally, the method involves at block 202, providing one or more databases (e.g., 118, 120, 122, 124) including a transaction table array comprising a series of tables.

As described above, each table is sorted by debit/credit network based on network fee amounts, each table is generated based on at least a discrete predetermined transaction amount, and the series of tables is based on a predetermined transaction table amount interval up to a cap amount. The transaction tables may be generated at intervals such as, 1 cent, 5 cent, 10 cent, 25 cent, 50 cent, 1 dollar, 2 dollar, 5 dollar, 7 dollar, 10 dollar, etc. intervals. Further, each table may also be generated based on merchant type, such as grocery merchant, clothing merchant, specialty merchant, banking merchant, restaurant merchant, etc. Alternatively, or additionally, each table may be generated based on transaction type, such as credit card transaction, debit card transaction, automated teller machine transaction, electronic finds transfer transaction, electronic check acceptance transaction, traditional check acceptance transaction, etc.

At block 204, server/computer (110) communicates with one or more databases (118, 120, 122, 124) and selects an appropriate transaction table from the transaction table array based at least on the amount of the transaction. More particularly, server/computer (110) may be configured, e.g., with computer implementable code capable of analyzing, e.g., the transaction amount, and rounding the transaction amount to the next highest transaction interval for which a transaction table has been generated. Server/computer (110) may then select transaction table corresponding to that transaction amount, i.e., the transaction table at the rounded-up transaction amount, as the appropriate transaction table for further processing. In certain embodiments, the transaction table may also be selected, and the transaction analyzed, based on at least merchant type and/or transaction type if desired.

Once the appropriate transaction table is selected from the transaction table array, at block 206, server/computer (110) determines the lowest cost debit/credit network from the selected transaction table to thereby determine the lowest cost debit/credit network for the transaction. By way of example, server/computer (110) may be configured, e.g., to include computer implementable code that is capable of performing table look up functions to determine the debit/credit network with the lowest associated network fee listed in the selected transaction table.

In certain embodiments, method 200 may continue at block 208, wherein server/computer (110) determines the availability of the first selected lowest cost debit/credit network for the transaction, and selects the next lowest cost debit/credit network that is available if the first selected lowest cost debit/credit network is not available. The availability check may continue down the list of debit/credit networks until the lowest cost debit/credit network that is available is determined. By way of example, the first selected lowest cost debit/credit network may not be available for any variety of reasons known in the art, such as the selected debit/credit network not being available for access by one or more of the parties to the electronic transaction, the selected debit/credit network experiencing technical difficulties, the communications network experiencing technical difficulties, etc.

Turning now to FIG. 3, a method 300 for routing an electronic transaction involving a merchant or ATM owner/operator and a financial institution which issues customer accounts through a lowest cost debit/credit network is illustrated. Again, although for ease of description, method 300 will be described by reference to system 100, those skilled in the art will understand that methods in accordance with various embodiments of the invention are not limited to any particular hardware or physical structure(s). In accordance with exemplary method 300, a method for routing an electronic transaction involving a merchant or ATM owner/operator and a financial institution issuing cardholder accounts through a lowest cost debit/credit network is provided, wherein method 300 generally includes at block 302, providing one or more databases (e.g., 118, 120, 122, 124) including a transaction table array comprising a series of tables.

Again, as described above, each table includes a list of debit/credit networks sorted based on network fee amounts charged by the debit/credit network for the particular transaction for which the table is generated, each table is generated based on at least a discrete predetermined transaction amount, and the series of tables is based on a predetermined transaction table amount interval up to a cap amount. The transaction tables may be generated at intervals such as, 1 cent, 5 cent, 10 cent, 25 cent, 50 cent, 1 dollar, 2 dollar, 5 dollar, 7 dollar, 10 dollar, etc. intervals. Further, each table may also be generated based on merchant type, such as grocery merchant, clothing merchant, specialty merchant, banking merchant, restaurant merchant, etc. Alternatively, or additionally, each table may be generated based on transaction type, such as credit card transaction, debit card transaction, automated teller machine transaction, electronic funds transfer transaction, electronic check acceptance transaction, traditional check acceptance transaction, etc.

At block 304, server/computer (110) communicates with one or more databases (118, 120, 122, 124) and selects an appropriate transaction table from the transaction table array based at least on the amount of the transaction. More particularly, server/computer (110) may be configured, e.g., with computer implementable code capable of analyzing, e.g., the transaction amount, and rounding the transaction amount to the next highest transaction interval for which a transaction table has been generated. Server/computer (110) may then select the transaction table corresponding to that transaction amount, i.e., the transaction table at the rounded-up transaction amount, as the appropriate transaction table for further processing. In certain embodiments, the transaction table may also be selected, and the transaction analyzed, based on at least merchant type and/or transaction type if desired.

Moving on, method 300 may continue at optional block 306, wherein debit/credit networks with preferred availability for the particular transaction to be routed may be determined. Block 306 may include step 306(a), wherein one or more databases (e.g., 118, 120, 122, 124) are provided including a merchant or ATM owner/operator network list which corresponds to a merchant or ATM owner/operator identification number. The merchant or ATM owner/operator network list includes the debit/credit networks available for access by the merchant or ATM owner/operator. Block 306 further includes step 306(b), wherein one or more databases (e.g., 118, 120, 122, 124) are provided including a financial institution network list which corresponds to a financial institution which issued a customer account number. Similarly, the financial institution network list includes the debit/credit networks available for access by the financial institution. Block 306 then continues to step 306(c), wherein, the debit/credit networks of the merchant or ATM owner/operator network list and the financial institution network list are matched, and a merchant or ATM owner/operator-financial institution network list is generated with the matched debit/credit networks of the merchant or ATM owner/operator network list and the financial institution network list to thereby determine the debit/credit networks with preferred availability for the particular transaction to be routed.

As another option, the financial institution network list may be evaluated to determine if any conflicts exist between or among rules to which a transaction may be routed. For example, the rules may specify that two different networks must be used. In cases where such conflicts exist, the process may proceed to step 308 (skipping step 306) to determine a least cost network.

In accordance with certain embodiments of the invention, when a transaction is processed for least cost routing, the merchant identification number associated with the merchant involved in the transaction is communicated to server/computer (110). The merchant number may be inputted into the system either automatically, e.g., from a point-of-sale device, cash register, automated teller machine, etc., or may be manually entered. By way of example, the merchant number may constitute a 16 byte number which uniquely identifies a merchant or merchant location, and may uniquely identify the merchant type. Initially, server/computer (110) may optionally determine whether the merchant or ATM owner identification number is valid. In determining whether the merchant or ATM owner number is valid, the server/computer (110) compares the merchant or ATM owner number with a number file stored in one or more databases (118, 120, 122, 124). In one embodiment, if the merchant or ATM owner number file shows that the merchant or ATM owner number is flagged for lowest cost routing analysis, then the system applies the present invention to the merchant transaction.

The merchant or ATM owner number file may include the following records: (1) the merchant or ATM owner number; (2) a debit/credit network list; (3) an optional transaction type list; (4) an optional merchant type; and (5) an optional lowest cost routing (LCR) flag. The debit/credit network list may be a byte record which is comprised of a list of debit/credit networks that the identified merchant or ATM owner/operator is capable of accessing and processing. The optional transaction type list may be a byte record which is a list of transaction types which the merchant or ATM owner/operator is capable of processing. The optional transaction type may be a one to three byte codes to indicate the type of merchant. The optional LCR flag indicates whether lowest cost routing should be performed for the identified merchant.

In accordance with certain embodiments of the invention, the customer account number associated with the financial institution involved in the transaction is communicated to server/computer (110). Again, the customer account number may be inputted into the system either automatically, e.g., from a point-of-sale device, cash register, automated teller machine, etc., or may be manually entered. Server/computer (110) then matches the account number for the customer against the financial institution number file. The financial institution number file of step 306(b) may include the following records: (1) BIN; (2) account number length; and (3) debit/credit network list. The BIN is usually a 12 byte record which identifies the banking institution. The account number length may be a 3 byte record which identifies the length of account numbers associated with the identified BIN (e.g., for account verification purposes). The debit/credit network list constitutes a list of debit/credit networks that will process account numbers associated with the identified BIN.

Once the corresponding account number length and BIN are matched with the records of the financial institution number file, a debit/credit network list which corresponds to the identified BIN is created. The present invention then performs a logical set intersection of the financial institution debit/credit network list and the merchant or ATM owner/operator network list to create a merchant-financial institution network list in step 306(c). The merchant-financial institution network list is comprised of the common elements of the merchant or ATM owner/operator network list and the financial institution network list.

Once the appropriate transaction table is selected from the transaction table array, at block 308, server/computer (110) determines the lowest cost debit/credit network from the selected transaction table to thereby determine the lowest cost debit/credit network for the transaction. By way of example, server/computer (110) may be configured, e.g., to include computer implementable code that is capable of performing table look up functions to determine the debit/credit network with the lowest associated network fee listed in the selected transaction table. In one embodiment, if optional block 306 is present, block 308 may include step 308(a), wherein the debit/credit networks sorted in the selected transaction table are cross-referenced with the debit/credit networks of the merchant-or ATM owner/operator financial institution network list to determine the debit/credit networks in common between the two, and the lowest cost debit/credit network in common between the two is determined at step 308(b). Method 300 then continues at block 312, where the transaction is routed through the determined lowest cost network.

In certain embodiments, method 300 may include optional block 310, wherein server/computer (110) determines the availability of the first selected lowest cost debit/credit network for the transaction, and selects the next lowest cost debit/credit network that is available if the first selected lowest cost debit/credit network is not available. The availability check may continue down the list of debit/credit networks until the lowest cost debit/credit network that is available is determined. By way of example, the first selected lowest cost debit/credit network may not be available for any variety of reasons known in the art, such as the selected debit/credit network experiencing technical difficulties, the communications network experiencing technical difficulties, etc.

In another aspect of the invention, various combinations of the methods illustrated in FIGS. 2 and 3 are envisioned. For instance, the routing step of method 300 may be implemented in method 200. Further, the specific order of the blocks shown in FIGS. 2 and 3 are not intended to be restrictive and in other embodiments, additional steps may be performed. For instance, in method 300, blocks 302, 304 and 306 may be performed in alternate order of operation.

Further, it is understood that in certain aspects of the invention, the methods are subject to the rules of operation of the various debit/credit networks as previously described. For instance, if required by network rules or agreement, the methods of the invention may select a debit/credit network based on network rule requires rather than LCR requirements, as previously described herein. In certain embodiments, the methods of the invention may comprise additional network rule checks to verify network rule compliance following table look-up. In other embodiments, the invention may take network rules into account when generating the various table arrays of the invention such that the LCR network priorities indicated in the tables reflect not only network fee considerations, but also network rule and regulation considerations.

In accordance with the methods of the present invention, selection of a lowest cost debit/credit network and least cost debit/credit network routing may be performed in a dynamic, yet time efficient manner. A traditional, static, over-arching fee table that does not take into account specific transaction parameters (e.g., merchant type, transaction type, subject of transaction, transaction amount, etc.), does not provide for dynamic, cost-efficient routing of electronic transactions. Although efficient from a time perspective, often such an approach will result in the selection of a less cost efficient debit/credit network. On the other hand, complex computational formulas for calculating the exact fees for multiple debit/credit networks to select the lowest fee debit/credit network, although dynamic and accurate, is operationally inefficient and time consuming.

Through the use of the transactional table array described herein, the present invention provides the time-efficiency of a simple table look up approach, while at the same time providing the dynamic-accuracy of a computational methodology. The transactional table array of the present invention is generated off-line from the time-sensitive electronic transaction taking into account transaction parameters. Then, once time becomes of importance during processing of the electronic transaction, the transactional table array provides a mechanism for a simple table look-up with the added accuracy of a dynamic computational formula.

In this way, embodiments in the invention provide novel systems and methods for determining a lowest cost debit and/or credit network for an electronic transaction and for routing such transactions. The description above identifies certain exemplary embodiments for implementing the invention, but those skilled in the art will recognize that many modifications and variations are possible within the scope of the invention. Therefore, the invention is defined only by the claims set forth below.

What is claimed is:

1. A method for determining a lowest cost debit/credit network for an electronic transaction, the method comprising:
providing a transaction table array comprising a series of tables, wherein each table includes a list of debit/credit networks sorted based at least in part on network fee amounts, each table is generated based at least in part on a discrete predetermined transaction amount, and the series of tables is based at least in part on a predetermined transaction table amount interval up to a cap amount;
selecting an appropriate transaction table from the transaction table array based at least in part on the amount of the transaction; and
determining the lowest cost debit/credit network from the selected transaction table to thereby determine the lowest cost debit/credit network for the transaction.

2. The method of claim 1, wherein the predetermined transaction table amount interval is selected from the group consisting of: 1 cent, 5 cent, 10 cent, 25 cent, 50 cent, 1 dollar, 5 dollar, 7 dollar, and 10 dollar intervals.

3. The method of claim 1, wherein each table is further generated based at least in part on merchant type.

4. The method of claim 3, wherein the appropriate table is selected based at least in part on at least merchant type and transaction amount.

5. The method of claim 3, wherein the merchant type comprises at least one of a grocery merchant, clothing merchant, specialty merchant, banking merchant, petroleum merchant, quick service restaurant merchant, and sit-down restaurant merchant.

6. The method of claim 1, wherein each table is further generated based at least in part on transaction type.

7. The method of claim 6, wherein the appropriate table is selected based at least in part on transaction type and transaction amount.

8. The method of claim 6, wherein the transaction type is selected from the group consisting of: credit card transaction, debit card transaction, automated teller machine transaction, electronic funds transfer transaction, electronic check acceptance transaction, and traditional check acceptance transaction.

9. The method of claim 1, further comprising determining the availability of the first selected lowest cost debit/credit network for the transaction, and selecting the next lowest cost debit/credit network that is available if the first selected lowest cost debit/credit network is not available.

10. A method of routing an electronic transaction involving a merchant or ATM owner/operator and a financial institution which issues customer accounts through a lowest cost debit/credit network for the transaction, the method comprising:
providing a merchant or ATM owner/operator network list which corresponds to a merchant or ATM owner/operator identification number, the merchant or ATM owner/operator network list comprising debit/credit networks available for access by the merchant or ATM owner/operator;
providing a financial institution network list which corresponds to a financial institution issuing a customer account, the financial institution network list comprising debit/credit networks available for access by the customer account;
providing a transaction table array comprising a series of tables, wherein each table includes a list of debit/credit networks sorted based at least in part on network fee amounts, each table is generated based at least in part on a discrete predetermined transaction amount, and the series of tables is based at least in part on a predetermined transaction table amount interval up to a cap amount;
matching the debit/credit networks of the merchant or ATM owner/operator network list and the financial institution network list and generating a merchant or ATM owner/operator-financial institution network list with the matched debit/credit networks of the merchant or ATM owner/operator network list and the financial institution network list;
selecting an appropriate transaction table from the transaction table array based at least in part on a transaction amount;
cross-referencing the debit/credit networks sorted in the selected transaction table with the debit/credit networks of the merchant or ATM owner/operator-financial institution network list;
determining the lowest cost debit/credit network in common between the selected transaction table and the merchant or ATM owner/operator-financial institution network list; and
routing the transaction through the determined lowest cost network.

11. The method of claim 10, wherein the predetermined transaction table amount interval comprising at least one of: 1 cent, 5 cent, 10 cent, 25 cent, 50 cent, 1 dollar, 2 dollar, 5 dollar, 7 dollar, and 10 dollar intervals.

12. The method of claim 10, wherein each table is further generated based at least in part on merchant type.

13. The method of claim 12, wherein the appropriate table is selected based at least in part on at least merchant type and transaction amount.

14. The method of claim 12, wherein the merchant type comprises at least one of a grocery merchant, clothing merchant, specialty merchant, banking merchant, petroleum merchant, quick service restaurant merchant, and sit-down restaurant merchant.

15. The method of claim 12, wherein merchant type is determined based at least in part on the merchant identification number.

16. The method of claim 10, wherein each table is further generated based at least in part on transaction type.

17. The method of claim 16, wherein the appropriate table is selected based at least in part on at least transaction type and transaction amount.

18. The method of claim 16, wherein the transaction type is selected from the group consisting of: credit card transaction, debit card transaction, automated teller machine transaction, electronic funds transfer transaction, electronic check acceptance transaction, and traditional check acceptance transaction.

19. The method of claim 10, further comprising determining the availability of the first selected lowest cost debit/credit network for the transaction, and selecting the next lowest cost debit/credit network that is available if the first selected lowest cost debit/credit network is not available.
